(19) United States
(12) Patent Application Publication
(10) Pub. No.: US 2010/0229790 A1
(43) Pub. Date: Sep. 16, 2010

(54) TRANSFER METHOD AND TRANSFER APPARATUS

(75) Inventors: Mitsuaki Serizawa, Numazu-shi (JP); Masayuki Yagi, Fuji-shi (JP)

Correspondence Address: DLA PIPER LLP US, P. O. BOX 2758, RESTON, VA, 20195, US

(73) Assignee: TOSHIBA KIKAI KABUSHIKI KAISHA, Chiyoda-ku, Tokyo (JP)

(21) Appl. No.: 12/740,816

(22) PCT Filed: Oct. 30, 2008
(86) PCT No.: PCT/JP2008/069769

§ 371 Date: Apr. 30, 2010

(30) Foreign Application Priority Data
Oct. 30, 2007 (JP) 2007-281043

(51) Int. Cl. B05D 3/12; B29C 59/04

(52) U.S. Cl. 118/44; 427/355; 427/365

(57) ABSTRACT

An intermittent coating member 10 delivers resin intermittently from a coating die 20 onto a length of base film 41 fed forth from a feeding member 40 to form intermittent coats of a coating film 43 on the base film 41. The coating film 43 is transferred to a transfer member 44 that actuates in synchronism with the coating action for the coating film 43, and is given a transfer by moulds 45 fixed on a mould roll 46. After the transfer, the coating film 43 is cured by an ultraviolet irradiation device 48 and wound up by a winding member 49.

### TECHNICAL FIELD

The present invention relates to a transfer method and a transfer apparatus using moulds to give a form of fine concavo-convex shapes on the surface of resin, and more particularly to a method and an apparatus to coat a base film with resin and press moulds on the resin to transfer concavo-convex patterns.

### BACKGROUND ART

As a method for forming concavo-convex patterns for optical recording media and the like, there has been known a transfer method in which moulds are pressed on resin such as an ultraviolet curable resin to give a form of the patterns. In this transfer method, as disclosed in Japanese Patent Application Laid-Open Publication No. H11-345436 (patent document 1), an ultraviolet curable resin is applied in a dispenser method or a roll transfer method on a length of resin sheet fed forth from a feeding member; and a stamper, which is moulds, is pressed on the applied ultraviolet curable resin to give a form, and on the ultraviolet curable resin given the form are irradiated ultraviolet rays to cure the resin.

As a method for applying resin on a resin sheet, besides the above-noted dispenser method and roll transfer method, there is one called a coating method in which resin is delivered from a coating die in a film form to be applied on a resin sheet. All the conventional coating methods are a method in which resin is applied in succession on a resin sheet.

However, the moulds for giving a form is not provided in succession all along a running direction of a resin sheet, but for example fixed on only a part of the periphery of a roll, as is same in patent document 1. It is thus common for a resin sheet to have a portion that is not pressed by the moulds.

In the portion not pressed by the moulds, the resin is to be cured without a transfer of patterns, resulting in a waste of resin. Further, since the resin is not to be moulded into grooves of the moulds, an excessive amount of application may lead to an overflow of the resin, causing troubles in operation.

Meanwhile, in the above-noted coating method, there is an intermittent coating method disclosed in Japanese Patent Application Laid-Open Publication No. 2002-45762. The intermittent coating method is a method in which a coating agent is applied intermittently on a sheeted substrate. By adopting the intermittent coating method into a transfer method that is the subject of the present invention, it is possible to have a highly advantageous transfer.

### DISCLOSURE OF THE INVENTION

It is an object of the present invention by adopting the above-noted intermittent coating method into the field of transfer to provide a transfer method and a transfer apparatus to prevent a waste of resin and to eliminate a supply of resin to a portion of a base film not pressed by moulds to enable an advantageous transfer.

To achieve the above-noted object, a transfer method according to an aspect of the present invention is a transfer method including coating a base film with resin, and pressing moulds on a coat of resin, to transfer concavo-convex patterns, the method comprising the steps of: intermittent-delivering resin from a coating die onto the base film; intermittent-coating the base film with delivered resin; and pressing the moulds on intermittent coats of resin in synchronism with the intermittent-coating, for transfer of the patterns.

A transfer apparatus according to an aspect of the present invention is a transfer apparatus to coat a base film with resin and press moulds on a coat of resin to transfer concavo-convex patterns, comprising: an intermittent coating member that intermittent-delivers resin from a coating die onto the base film and intermittent-coats the base film with delivered resin; a transfer member that presses the moulds on intermittent coats of resin in synchronism with the intermittent-coating, for transfer of the patterns; and a synchronism control member that actuates the intermittent coating member and the transfer member in synchronism.

### BRIEF DESCRIPTION OF THE DRAWINGS

FIG. 1 is a schematic configuration view illustrating an embodiment of a transfer apparatus according to the present invention.

FIG. 2 is an enlarged view illustrating moulds and a mould roll in FIG. 1. FIG. 2(a) is a plane view, and FIG. 2(b) is a side view.

FIG. 3 is a schematic configuration view illustrating an example of an intermittent coating member in FIG. 1.

FIG. 4 is a schematic configuration view illustrating another embodiment of a transfer apparatus according to the present invention.

### BEST MODE FOR CARRYING OUT THE INVENTION

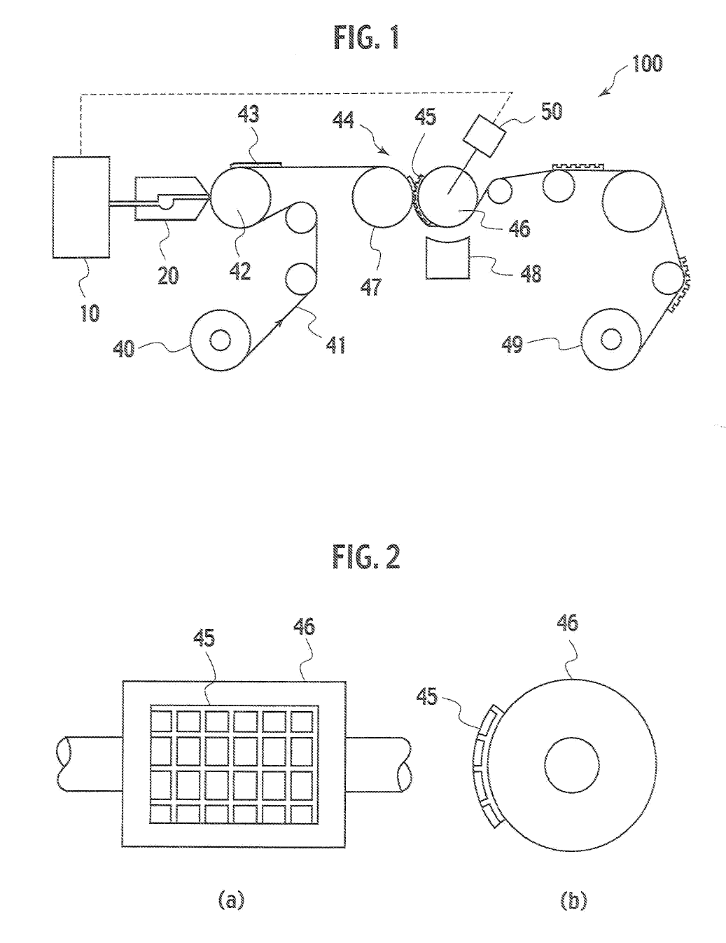

Description is made of an embodiment of the present invention with reference to FIG. 1 to FIG. 3. FIG. 1 is a schematic configuration view of a transfer apparatus according to the present invention. A transfer apparatus 100 is configured with an intermittent coating member 10 including a coating die 20 (described in detail later on).

The coating die 20 is arranged opposite to the periphery of a backup roll 42 that winds on and runs a length of base film 41 fed forth from a feeding member 40. The coating die 20 is adapted for a coating on the base film that is an intermittent application as will be described later on, of coats of a coating film 43 made of an ultraviolet curable resin, for instance.

A transfer member 44 includes: a mould roll 46 with moulds (moulds of a roll type) 45 fixed on the periphery thereof; a press roll 47 closely aligned to the mould roll 46 in pairs; and an ultraviolet irradiation device 48 opposed to the mould roll 46. Since these are configured similar to a typical transfer apparatus, description in detail will be omitted, while the moulds 45 are fixed on only a part of the periphery of the mould roll 46 as illustrated in FIG. 2.

After a transfer on the coating film 43 at the transfer member 44 with the moulds 45, the base film 41 is wound up by a winding member 49.

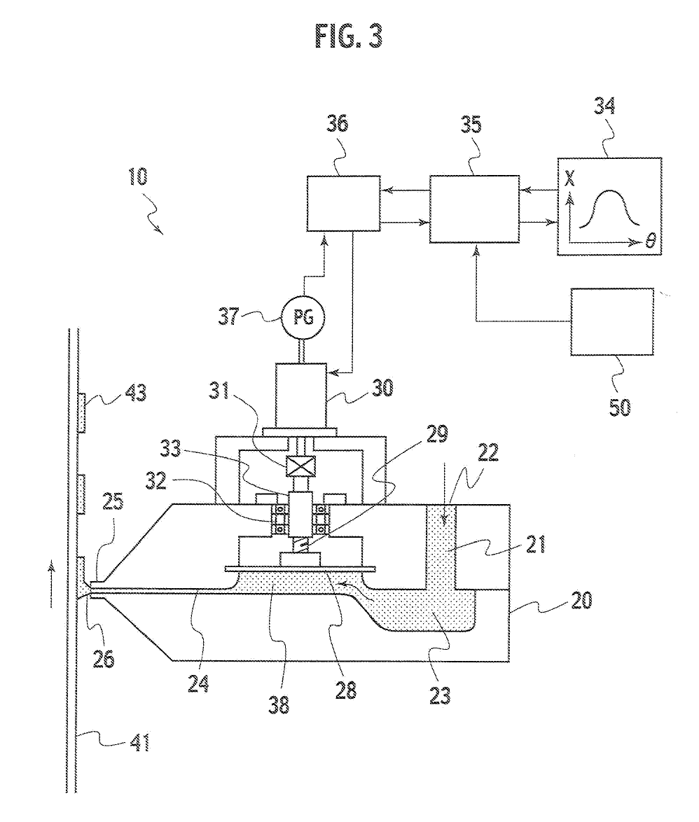

FIG. 3 illustrates an example of the intermittent coating member 10, which is one described in the above-noted patent document 2. At the intermittent coating member 10, the coating die (applying die) 20 has a coating agent 21 introduced thereto from an inlet 22. The coating agent 21 is kept once in a manifold 23 and then delivered through a supply path 24 to an outlet 26 provided at a lip 25, in a film form to be applied on the surface of a substrate traveling in the upper direction (direction shown in an arrow), that is the base film 41 illustrated in FIG. 1.

On the supply path 24, there is provided a diaphragm 28 that configures a part of the path. The diaphragm 28 has a screw axis 29 coupled thereto. The screw axis 29 is screwed into a ball nut 33 that is mounted for rotation-only by a bearing 32. The ball nut 33 has a servomotor 30 coupled thereto through a coupling 31.

The servomotor 30 has rotation amount and rotation speed thereof to be regulated automatically by a controller 35, a servo driver 36 and a pulse generator 37. The servomotor 30 is configured to displace the diaphragm 28 for a displacement amount ‘X’ of the diaphragm 28 against a rotation angle θ of the ball nut 33 to satisfy a relationship in a displacement setting curve 34.

When the diaphragm 28 is displaced upward to thereby increase the volume of a coating agent lead-in space 38, the coating agent 21 introduced from the inlet 22 is led and stored in the space 38. Accordingly, when the diaphragm 28 is displaced upward, it stops the delivery of the coating agent 21 at the outlet 26.

On the other hand, when the diaphragm 28 is displaced downward to thereby decrease the volume of the coating agent lead-in space 38, the coating agent 21 stored in the coating agent lead-in space 38 is delivered through the supply path 24 and brought together with the coating agent 21 introduced from the inlet 22 to be delivered at the outlet 26. This enables the intermittent application of the coating film 43 on the base film 41 as illustrated in FIG. 3.

The controller 35 for the intermittent coating member 10 has a travel distance measurement device 50 connected thereto. The travel distance measurement device 50 is mounted to the mould roll 46 to measure a travel distance of the base film 41 as illustrated in FIG. 1. The travel distance measurement device 50 constitutes a synchronism control member that synchronizes the intermittent coating member 10 and the transfer member 44. The synchronism control member is configured to actuate the intermittent coating member 10 in synchronism with rotation of the mould roll 46, that is in synchronism with a travel distance of the base film 41, to align each coat of the coating film 43 on the base film 41 with the moulds 45 on the mould roll 46.

Description is now made of actions of the apparatus. There is a length of base film 41 fed forth from the feeding member 40 on which the intermittent coating member 10 provides an intermittent application of coats of a coating film 43 made of an ultraviolet curable resin that is the coating agent 21 delivered intermittently from the coating die 20.

Each coat of the coating film 43 on the base film 41 is delivered to the transfer member 44 by the travel of the base film 41 to be given a transfer by the moulds 45 on the mould roll 46 and the pressure roll 47. On this occasion, since each coat of the coating film 43 has been formed on an area limited to a portion facing to the moulds 45, it prevents the waste of ultra curable resin to form the coating film 43 and also eliminates the supply of resin to a portion not facing to the moulds 45 and the concavo-convex patterns thereof. It is thus possible to have an advantageous transfer without troubles by an overflow of the resin to affect operation, or the like.

Each coat of the coating film 43, which is given a transfer, is cured with the ultraviolet irradiation device 48 to finish the transfer step and is wound up along with the base film 41 by the winding member 49.

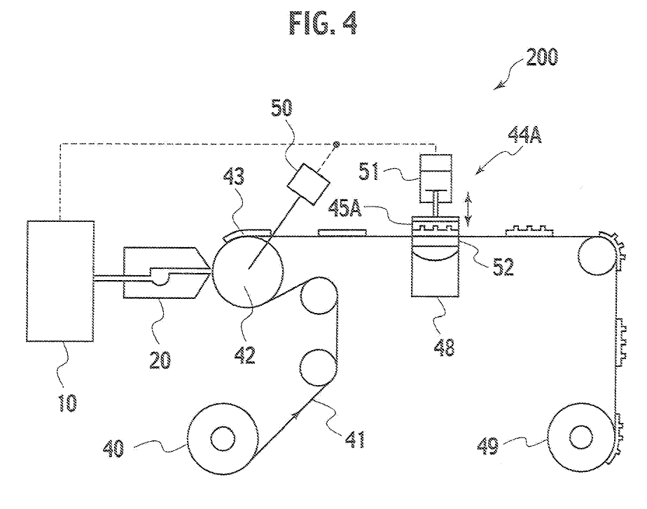

FIG. 4 is a schematic configuration view of another embodiment according to the present invention. The embodiment in FIG. 1 describes an example to use the moulds of a roll type 45 fixed on the mould roll 46 adapted for continuous rotation and to run the base film 41 continuously. Instead, this embodiment describes to use a transfer member 44A with moulds of a press type 45A that are opposed each other to open and close and to run the base film 41 intermittently, where a length of base film 41 is intermittently fed forth from the feeding member 40 and intermittently wound up by the winding member 49.

The transfer member 44A is provided with: a pressure device 51 to open and close to press the moulds 45A; and a supporting plate 52 that is transparent. The travel distance measurement device 50 is mounted to the backup roll 42 and configured to actuate the intermittent coating member 10 and the transfer member 44A in synchronism with a travel distance of the base film 41.

The apparatus provides an intermittent application of coats of a coating film 43 with the intermittent coating member 10 on the base film 41 traveling intermittently, stops each coat of the coating film 43 at a position corresponding to the transfer member 44A, and implements a transfer by the moulds of a press type 45A during the stop. With the apparatus, it is possible to achieve the same effect with that of the apparatus in FIG. 1.

The aforementioned embodiment describes an example of providing the coating agent lead-in space 38 to the coating die 20, which is used for an intermittent delivery of the coating agent 21 at the outlet 26 of the intermittent coating member 10. The invention, however, is not limited to the present configuration. It is possible to provide the coating agent lead-in space 38 upstream of the coating agent supply path near the inlet 22. Also, as means of increasing and decreasing the volume of the coating agent lead-in space 38, it is possible not to limit to the diaphragm 28 but to employ various intermittent coating devices such as cylinder and piston, or the like. Further, needless to say, as a resin to form the coating film 43, it is possible not to limit to an ultraviolet curable resin, but to employ another resin like a heat curable resin, or the like.

As apparent from the previous description, the present invention provides to intermittent-deliver resin from the coating die onto the base film, to intermittent-coat the base film with the resin, and to press the moulds on the intermittent coats of resin in synchronism with the intermittent coating for transfer of the concavo-convex patterns. This achieves the effect of preventing a waste of resin and eliminating a supply of resin on the portion not facing to the moulds to enable an advantageous transfer.

### INDUSTRIAL APPLICATION

The present invention will be applied to a transfer method and a transfer apparatus to coat a base film with resin and press moulds intermittently on the resin to transfer concavo-convex patterns.

1. A transfer method including coating a base film with resin, and pressing moulds on a coat of resin, to transfer concavo-convex patterns, the method comprising the steps of:
intermittent-delivering resin from a coating die onto the base film;
intermittent-coating the base film with delivered resin; and
pressing the moulds on intermittent coats of resin in synchronism with the intermittent-coating, for transfer of the patterns.

2. The transfer method according to claim 1,
wherein the synchronism of the intermittent-coating and the transfer is on the basis of a travel distance of the base film.

3. The transfer method according to claim 1,
wherein the base film travels continuously, and the transfer is implemented by moulds of a roll type fixed on a periphery of a roll adapted for continuous rotation.

4. The transfer method according to claim 1,
wherein the base film travels intermittently, and the transfer is implemented by moulds of a press type opposed each other to open and close.

5. A transfer apparatus to coat a base film with resin and press moulds on a coat of resin to transfer concavo-convex patterns, comprising:
an intermittent coating member that intermittent-delivers resin from a coating die onto the base film and intermittent-coats the base film with delivered resin;
a transfer member that presses the moulds on intermittent coats of resin in synchronism with the intermittent-coating, for transfer of the patterns; and
a synchronism control member that actuates the intermittent coating member and the transfer member in synchronism.

6. The transfer apparatus according to claim 5,
wherein the synchronism control member has a travel distance measurement device for the base film and synchronizes the intermittent coating member and the transfer member on the basis of a travel distance of the base film.

7. The transfer apparatus according to claim 5,
wherein the moulds are moulds of a roll type fixed on a periphery of a roll adapted for continuous rotation.

8. The transfer apparatus according to claim 5,
wherein the moulds are moulds of a press type opposed each other to open and close.
